(19) United States
(12) Patent Application Publication
(10) Pub. No.: US 2018/0266335 A1
(43) Pub. Date: Sep. 20, 2018

(54) ELECTRONIC THROTTLE

(71) Applicant: Continental Automotive GmbH, Hannover (DE)

(72) Inventors: Wei ZHU, Jinghu Zone/Wuhu (CN); Qin WANG, Dangtu (CN)

(73) Assignee: Continental Automotive GmbH, Hannover (DE)

(21) Appl. No.: 15/982,702

(22) Filed: May 17, 2018

Related U.S. Application Data
(63) Continuation of application No. PCT/EP2016/077986, filed on Nov. 17, 2016.

(30) Foreign Application Priority Data
Nov. 19, 2015 (CN) 201520926271.X

(51) Int. Cl. F02D 9/10

(52) U.S. Cl. CPC F02D 9/106; F02D 9/105; F02D 9/104

(57) ABSTRACT

An electronic throttle, including: a throttle housing and, located inside the throttle housing: an electric machine; a torque transfer means; a throttle shaft and a butterfly valve. The throttle shaft passes through a throttle throat, and is supported by being inserted into a first mounting hole and a second mounting hole in the throttle housing, wherein the first mounting hole and the second mounting hole are located in the throttle housing on two sides of the throttle throat respectively, the second mounting hole being located on that side which is closer to the torque transfer means, and the first mounting hole and second mounting hole having inner diameters of the same size. The throttle according to the present device has the advantages of simple component structure, low costs and ease of processing.

### CROSS-REFERENCE TO RELATED APPLICATIONS

This application claims the benefit of PCT Application PCT/EP2016/077986, filed Nov. 17, 2016, which claims priority to Chinese Patent Application 201520926271.X, filed Nov. 19, 2015. The disclosure of the above application is incorporated herein by reference.

### FIELD OF THE INVENTION

The present device relates to a motor vehicle component product, in particular to an electronic throttle for use in a motor vehicle motive power assembly.

### BACKGROUND OF THE INVENTION

A throttle device is generally provided in an internal combustion engine, arranged upstream of the air intake manifold and in communication with the air intake pipeline. It is used to control the flow rate of air supplied to the air intake manifold, and thereby control the flow rate of air entering the engine cylinders.

Commonly used throttles on the market at present have the following structural features: 1) a throttle shaft thereof must always be supported by bearings (e.g. needle roller bearings) mounted in throttle mounting holes on two sides of the throat; 2) a sealing plug is mounted in one of the bearing mounting holes to achieve sealing; 3) locating is performed by mounting a C-shaped washer on the throttle shaft; 4) a seal is always contained inside a needle roller bearing or roller bearing mounted in a bearing mounting hole on one side of a gearbox, and one side of the gearbox inside the throttle is sealed by means of the seal; 5) the throat of the throttle contains no insert, or contains an insert but has a complex structure.

A throttle having the structural features described above has the following drawbacks: 1) During machining, the precision requirements for the positions of the two bearing mounting holes are very high; high equipment processing precision is needed, the processing time is long, and the rejection rate is high. 2) A high-precision adjusting apparatus is needed to adjust axial gaps; costs are increased, adjustment is difficult, and the rejection rate is high. 3) Since the seal is integrated in the interior of the needle roller bearing or roller bearing, regions which are exposed outside the seal are very easily corroded by external media; in extreme cases, this results in the throttle being unable to regulate airflow normally. In order to enable the seal to be integrated in the needle roller or roller bearing and ensure the reliability of sealing and a smaller frictional torque, the structure of the seal will have a complex design, resulting in a high price and making manufacture difficult. Moreover, since single-point sealing is required, the inside surface of the bearing outer ring and the throttle shaft are required to be of very high quality in the case where the sealing pressure is not high. 4) A single-piece throttle valve body made of a metal material is heavy, involves a complex process, causes serious pollution, and has high production costs.

### SUMMARY OF THE INVENTION

The object of the present device is to provide an electronic throttle, to solve the following problems which affect existing throttles: 1) component processing precision is low, while processing equipment requirements are high; 2) a precise instrument is needed to perform axial gap adjustment during axial positioning of the throttle shaft; 3) the sealing structure is complex, components outside the seal may cause corrosion, and manufacturing is difficult; 4) the manufacturing cost is high, and pollution is serious.

The electronic throttle provided by the present device includes: a throttle housing 1 and, located inside the throttle housing 1: an electric machine 2; a torque transfer means 3 meshed with a gear on an output shaft of the electric machine 2; a throttle shaft 4 connected in a fixed manner to the torque transfer means 3, the throttle shaft 4 passing through a throttle throat, and being supported by being inserted into a first mounting hole 6 and a second mounting hole 7 in the throttle housing 1, wherein the first mounting hole 6 and the second mounting hole 7 are located in the throttle housing 1 on two sides of the throttle throat respectively, the second mounting hole 7 being located on that side which is closer to the torque transfer means 3; a butterfly valve 5 which is mounted on the throttle shaft 4 and located inside the throttle throat; the first mounting hole 6 and second mounting hole 7 having hole inner diameters of the same size.

Furthermore, a third mounting hole 8, located in the throttle housing 1 and used for supporting the throttle shaft 4, the third mounting hole 8 being located between the second mounting hole 7 and the torque transfer means 3 and being in communication with the second mounting hole 7.

Furthermore, inside the third mounting hole 8 are mounted a supporting bearing 9 which forms a clearance fit with the throttle shaft 4 and a sealing ring 10 mounted on the periphery of the throttle shaft 4; the sealing ring 10 may be located on either side of the supporting bearing 9.

Furthermore, an interference fit is formed between an inner ring of the sealing ring 10 and the throttle shaft 4, and an interference fit is formed between an outer ring of the sealing ring 10 and the third mounting hole 8.

Furthermore, the cross-sectional shape of the sealing ring 10 may be any one of the following shapes: X-shaped, B-shaped, Y-shaped, O-shaped or rectangular.

Furthermore, there is a gap 11 between the supporting bearing 9 and the sealing ring 10 in the axial direction of the throttle shaft 4.

Furthermore, the supporting bearing 9 is a sliding bearing.

Furthermore, an oil/grease or molybdenum disulphide is spread between the first mounting hole 6 and the throttle shaft 4.

Furthermore, a first locating pin mounting groove 61 is formed on the throttle housing 1; a second locating pin mounting groove 41 is formed on the throttle shaft 4; a space between the first locating pin mounting groove 61 and the second locating pin mounting groove 41 forms a locating pin mounting hole 12.

Furthermore, the electronic throttle also includes a locating pin 11 mounted inside the locating pin mounting hole 12.

Furthermore, the first locating pin mounting groove 61, second locating pin mounting groove 41, locating pin mounting hole 12 and locating pin 11 are all located inside the first mounting hole 6.

Furthermore, the first mounting hole 6 is a blind hole.

Furthermore, at least one small boss structure 13 is formed at the bottom of the first mounting hole 6.

Furthermore, an end face of the throttle shaft 4 located inside the first mounting hole 6 and a top surface of the boss structure 13 are in contact with and press against each other.

Furthermore, a gap 14 is formed between an end face of the throttle shaft 4 located inside the first mounting hole 6 and the bottom of the first mounting hole 6.

Furthermore, the electronic throttle also includes: an insert 15 mounted inside the throttle housing 1.

Furthermore, the insert 15 is an annular three-dimensional structure formed and enclosed by a first flange face 16, a second flange face 17, an outer cylindrical face 18 and an inner cylindrical face 19, the inner cylindrical face 19 of the insert 15 forming the throat of the throttle; a front shaft hole 20 and a rear shaft hole 21, positioned opposite each other, are formed in the insert 15; one end of the throttle shaft 4 is inserted into the front shaft hole 20 and then mounted in the second mounting hole 7 and third mounting hole 8; the other end of the throttle shaft 4 is inserted into the rear shaft hole 21 and then mounted in the first mounting hole 6; multiple axial holes 22 running in the axial direction of the insert 15 are formed on the first flange face 16 of the insert 15, each axial hole 22 being located between the outer cylindrical face 18 and the inner cylindrical face 19, and the interior of each axial hole 22 being filled with the material from which the throttle housing 1 is manufactured. Each of the axial holes 22 is surrounded by a flange 23, the flange 23 being a protruding structure located on the outer cylindrical face 18 of the insert 15. Two flanges 23 are distributed symmetrically on two sides of the front shaft hole 20, with a pin hole 24 being formed on each flange 23. The two pin holes 24 on the two flanges 23 distributed symmetrically on two sides of the front shaft hole 20 are distributed on two sides of the axis center of the throttle shaft 4. The protrusion height of the two flanges 23 on two sides of the front shaft hole 20 is greater than the protrusion height of the flanges 23 in other positions on the insert 15. Each of the flanges 23 extends from the first flange face 16 of the insert 15 to the second flange face 17. The interiors of the front shaft hole 20 and rear shaft hole 21 are partially filled with the material from which the throttle housing 1 is manufactured. The axial holes 22 penetrate to the second flange face 17 from the first flange face 16 of the insert 15.

Optionally, the insert 15 is an annular three-dimensional structure formed and enclosed by a first flange face 33, a second flange face 34, an inner cylindrical face 35 and an outer cylindrical face 36, the inner cylindrical face 35 of the insert 15 forming the throat of the throttle; a front shaft hole 37 and a rear shaft hole 38, positioned opposite each other, are formed in the insert 15; one end of the throttle shaft 4 is inserted into the front shaft hole 37 and then mounted in the second mounting hole 7 and third mounting hole 8; the other end of the throttle shaft 4 is inserted into the rear shaft hole 38 and then mounted in the first mounting hole 6; multiple protruding structures 39 and the same number of recess structures 40 are formed on the first flange face 33 of the insert 15; any two adjacent protruding structures 39 are separated by one recess structure 40. Each of the protruding structures 39 has one side connected to the outer cylindrical face 36 of the insert 15. Provided on the outer cylindrical face 36 are at least two arcuate grooves 42 extending from the first flange face 33 to the second flange face 34, each of the arcuate grooves 42 sharing an edge with one of the recess structures 40. Two flanges 43 are distributed symmetrically on two sides of the front shaft hole 37 on the outer cylindrical face 36, with a pin hole 44 being formed on each flange 43, and the two pin holes 44 being distributed on two sides of the axis center of the throttle shaft 4. The interiors of the front shaft hole 37 and rear shaft hole 38 are partially filled with the material from which the throttle housing 1 is manufactured.

Furthermore, an outer cover assembly 25 fitted to the housing 1, an electrical connector 26 for supplying power to the electric machine 2 and transmitting signals, a magnet 27 mounted on the torque transfer means 3, and a position sensor 28 mounted inside the outer cover assembly 25.

Compared with the prior art, the use of the electronic throttle provided by the present device has the advantages of a simple structure, high processing precision, good sealing, low manufacturing costs, and a simple assembly process flow.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which form part of the present application, are used to furnish further understanding of the present device. The schematic embodiments of the present device and the explanations thereof are intended to explain the present device, without constituting an inappropriate limitation thereof. Drawings:

FIG. 1 is a schematic exploded view of the components of the throttle of the present device;

FIG. 2 is a schematic sectional view of the throttle of the present device after assembly;

FIG. 3A is a front view of the throttle housing of the present device;

FIG. 3B is an enlarged schematic view of part A shown in FIG. 3A;

FIG. 3C is an enlarged schematic view of part B shown in FIG. 3A;

FIG. 4A is an enlarged schematic view of part C shown in FIG. 2;

FIG. 4B is a schematic perspective view of the sealing ring shown in FIG. 4A;

FIG. 4C is a sectional front view of the sealing ring shown in FIG. 4B;

FIG. 5A is an enlarged schematic view of part D shown in FIG. 2;

FIG. 5B is a schematic top view of the bottom of the blind hole shown in FIG. 5A (in the case where no throttle shaft is mounted);

FIG. 6 is a schematic perspective view of one embodiment of the insert;

FIG. 7 is a front view of the insert shown in FIG. 6;

FIG. 8 is a schematic perspective view of another embodiment of the insert; and

FIG. 9 is a front view of the insert shown in FIG. 8.

### DETAILED DESCRIPTION OF THE PREFERRED EMBODIMENT

The following description of the preferred embodiment(s) is merely exemplary in nature and is in no way intended to limit the invention, its application, or uses.

The electronic throttle of the present device is described below by way of embodiments with reference to the accompanying drawings.

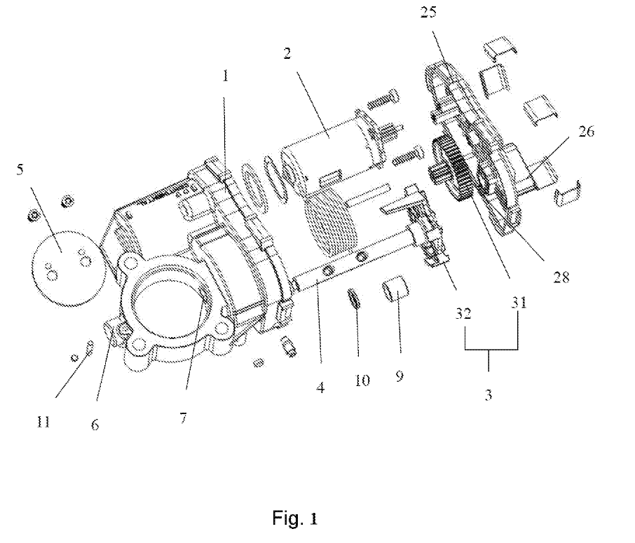

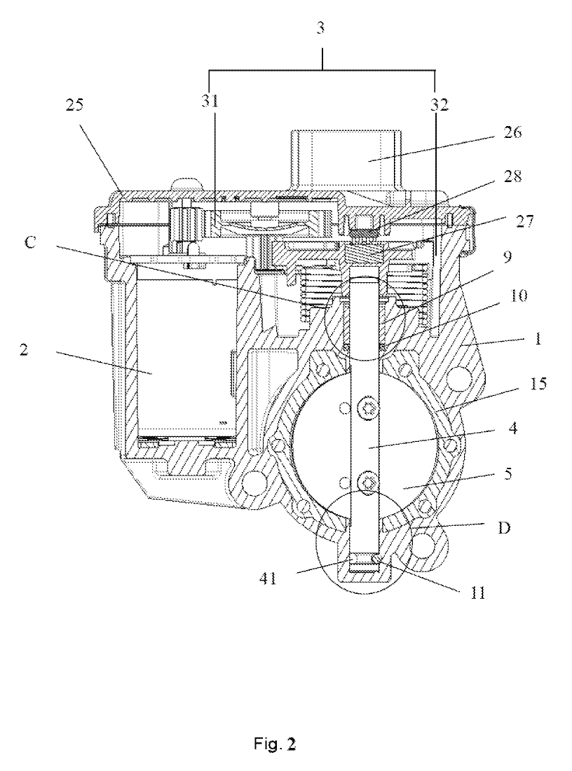

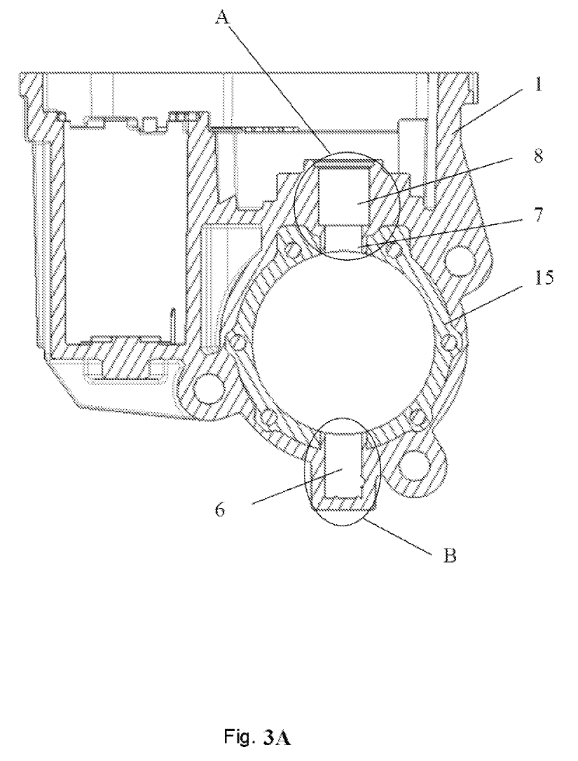

FIG. 1 is a schematic exploded view of the components of the throttle of the present device. FIG. 2 is a schematic sectional view of the throttle of the present device after assembly. FIG. 3A is a front view of the throttle housing of the present device. FIG. 3B is an enlarged schematic view of part A shown in FIG. 3A. FIG. 3C is an enlarged schematic view of part B shown in FIG. 3A. As FIGS. 1 and 2 show, the throttle includes: a throttle housing 1 for providing support and a protective function, and an electric machine 2 located inside the throttle housing 1, the electric machine 2 being used for supplying a torque; a torque transfer means 3 meshed with a gear on an output shaft of the electric machine 2, wherein in this embodiment, the torque transfer means may include an intermediate gear 31 meshed with the output gear of the electric machine 2 (the intermediate gear 31 being mounted on an intermediate shaft on the throttle housing 1), and a sector gear 32 meshed with the intermediate gear 31, with a return spring being mounted on the sector gear 32; a throttle shaft 4 connected in a fixed manner to the torque transfer means 3 (connected in a fixed manner to the sector gear 32), wherein an output torque of the electric machine 2 is transferred to the throttle shaft 4 via the torque transfer means 3, and the throttle shaft 4 passes through a throttle throat and is supported by being inserted into a first mounting hole 6 and a second mounting hole 7 in the throttle housing 1, wherein the first mounting hole 6 and the second mounting hole 7 are located in the throttle housing on two sides respectively of the throttle throat, the second mounting hole 7 being located on that side which is closer to the torque transfer means 3; and a butterfly valve 5 which is mounted on the throttle shaft 4 and located inside the throttle throat, the butterfly valve 5 being capable of rotating together with the throttle shaft 4, so as to control the degree of opening of the throttle throat.

Preferably, to reduce the machining difficulty, the rejection rate and costs, in this embodiment the first mounting hole 6 and second mounting hole 7 have hole inner diameters of the same size; as FIGS. 3B and 3C show, the inner diameter d2 of the first mounting hole 6 is equal to the inner diameter d1 of the second mounting hole 7, and as FIGS. 2, 3A and 3C show, the first mounting hole 6 has a blind hole design. Regardless of whether the throttle housing 1 is of metal material or plastic material, the abovementioned blind hole design is suitable. In the case of a metal housing, a forming cutter may be used to form the first mounting hole 6 and second mounting hole 7 in a single operation from the side on which the second mounting hole 7 is located, thereby increasing the precision of hole positioning and lowering the requirements on equipment capability, as well as reducing the number of processing cutters and saving time and costs. In the case of a plastic housing, only one mandrel is needed for core pulling, the precision of hole positioning may be increased, the mold scheme is simple, and the cost of injection molding is reduced. Moreover, when the first mounting hole 6 is a blind hole, sealing is better, the system leakage amount can be reduced effectively, no machining and subsequent press-fitting is needed, the number of components is small, and the cost is low.

Preferably, as FIGS. 2, 3A and 4A show, the electronic throttle also includes a third mounting hole 8 which is located in the throttle housing 1 and used for supporting the throttle shaft 4, the third mounting hole 8 being located between the second mounting hole 7 and the torque transfer means 3 and being in communication with the second mounting hole 7; in general, the inner diameter of the third mounting hole 8 is greater than the inner diameter of the second mounting hole 7.

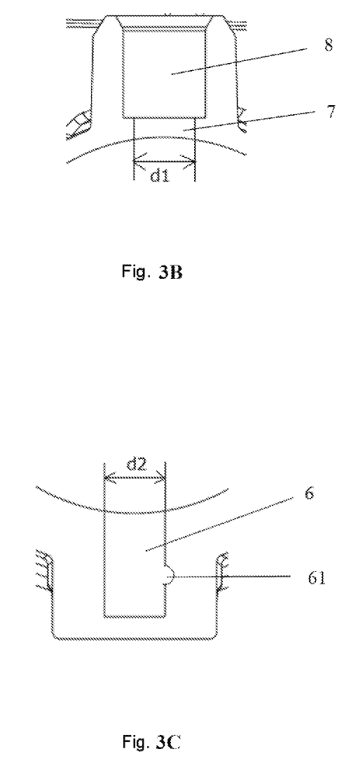

Preferably, as FIG. 4A shows, inside the third mounting hole 8 are mounted a supporting bearing 9 which forms a clearance fit with the throttle shaft 4 and a sealing ring 10 mounted on the periphery of the throttle shaft 4; the sealing ring 10 may be located on either side of the supporting bearing 9. The supporting bearing 9 may be a sliding bearing, with an interference fit between an outer ring thereof and the third mounting hole 8. In this embodiment, the sealing ring 10 is preferably located between the supporting bearing 9 and the second mounting hole 7.

Preferably, an interference fit is formed between an inner ring of the sealing ring 10 and the throttle shaft 4, and an interference fit is formed between an outer ring of the sealing ring 10 and the third mounting hole 8.

Preferably, as FIGS. 4B and 4C show, the sealing ring 10 is similar to an annular structure; the cross-sectional shape thereof may be X-shaped, B-shaped, Y-shaped, O-shaped or rectangular, but in this embodiment is preferably X-shaped (FIG. 4C); this is because in this case, the inner ring and outer ring of the sealing ring will each form two protruding points, such that two sealing lips are formed between the sealing ring 10 and the throttle shaft 4, and between the sealing ring 10 and the third mounting hole 8, respectively; such an X-shaped structure is more stable, and not liable to experience twisting deformation which would impair the sealing effect.

Preferably, as FIG. 4A shows, the sealing ring 10 is located outside the supporting bearing 9, and there is a gap 11 between the sealing ring 10 and the supporting bearing 9 in the axial direction of the supporting bearing 9.

Preferably, to achieve the object of reducing friction, an oil/grease or molybdenum disulphide is provided between the first mounting hole 6 and the throttle shaft 4.

Preferably, to simplify components, and reduce the difficulty of design and assembly, the interior of the supporting bearing 9 no longer contains another seal.

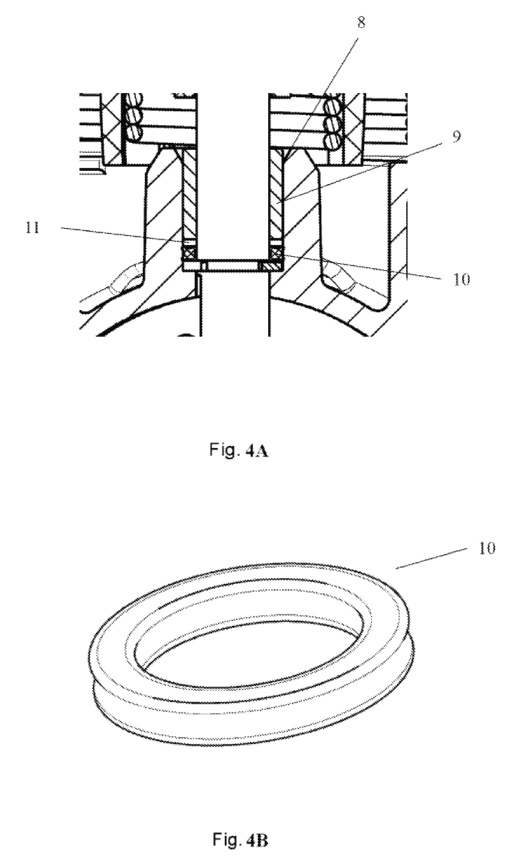

Preferably, as FIGS. 5A and 5B show, a first locating pin mounting groove 61 is formed on the throttle housing 1, and a second locating pin mounting groove 41 is formed on the throttle shaft 4 (the second locating pin mounting groove 41 may be a groove which runs all the way round the outer surface of the throttle shaft 4); a space between the first locating pin mounting groove 61 and the second locating pin mounting groove 41 forms a locating pin mounting hole 12.

Preferably, the electronic throttle also includes a locating pin 11 mounted inside the locating pin mounting hole 12.

Preferably, the first locating pin mounting groove 61, second locating pin mounting groove 41, locating pin mounting hole 12 and locating pin 11 are all located inside the first mounting hole 6.

Preferably, at least one small boss structure 13 is formed at the bottom of the first mounting hole 6. (In this embodiment, there are three such boss structures 13.) In terms of function, the boss structure 13 is used to set an initial positioning face on the throttle housing 1, for performing initial positioning of the throttle shaft 4, and the first locating pin mounting groove 61 is set on the throttle housing 1, for determining a final stop position of the throttle shaft 4. There is a designed positional relationship between the positioning face formed by the boss structure 13 and the first locating pin mounting groove 61; the position tolerance thereof must be designed to be +/−0.3 mm or less. Moreover, an end face of the throttle shaft 4 located inside the first mounting hole 6 and a top surface of the boss structure 13 may be in contact with and press against each other, with a gap 14 being formed between an end face of the throttle shaft 4 located inside the first mounting hole 6 and the bottom of the first mounting hole 6. The function of the gap 14 is to prevent the throttle shaft 4 from becoming jammed in the throttle housing 1 due to the action of expansion upon heating and contraction upon cooling during operation of the throttle.

Preferably, the electronic throttle also includes: an insert 15 mounted inside the throttle housing 1. Many schemes are possible for the structure of the insert 15; two preferred schemes are described in this embodiment:

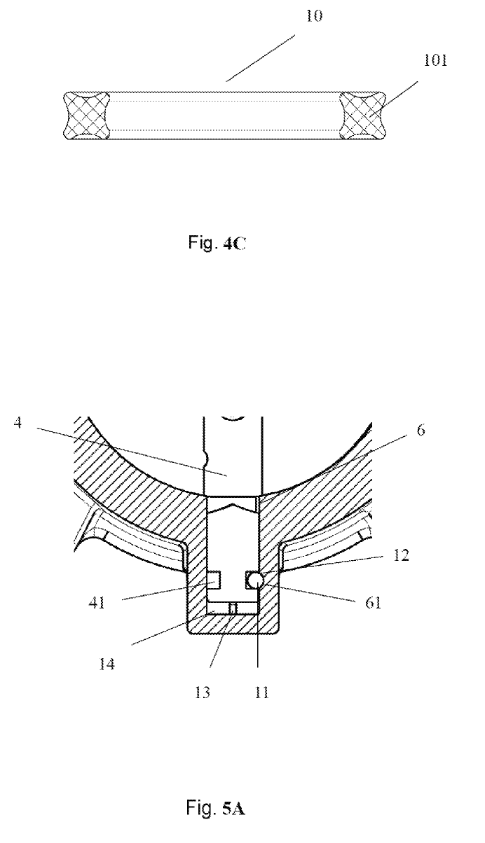

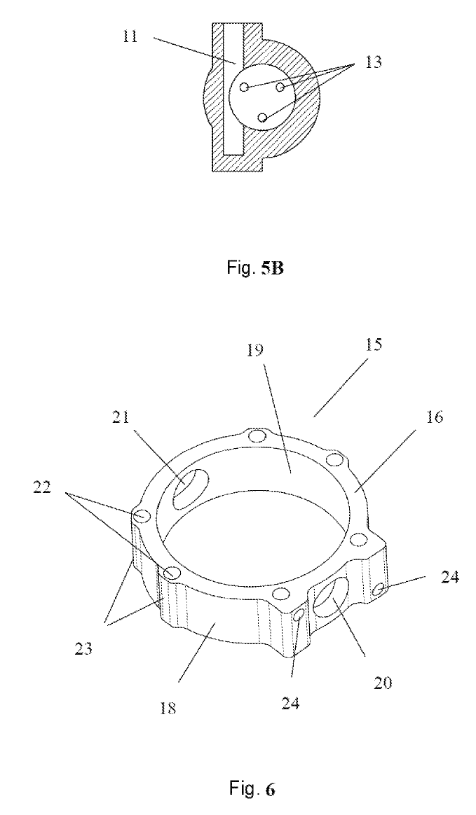

The first scheme is shown in FIGS. 2, 6 and 7. The insert 15 is an annular three-dimensional structure formed and enclosed by a first flange face 16, a second flange face 17, an outer cylindrical face 18 and an inner cylindrical face 19, the inner cylindrical face 19 of the insert 15 forming the throat of the throttle. A front shaft hole 20 and a rear shaft hole 21, positioned opposite each other, are formed in the insert 15. One end of the throttle shaft 4 is inserted into the front shaft hole 20 and then mounted in the second mounting hole 7 and third mounting hole 8. The other end of the throttle shaft 4 is inserted into the rear shaft hole 21 and then mounted in the first mounting hole 6. Multiple axial holes 22 running in the axial direction of the insert 15 are formed on the first flange face 16 of the insert 15, each axial hole 22 being located between the outer cylindrical face 18 and the inner cylindrical face 19, and the interior of each axial hole 22 being filled with the material from which the throttle housing 1 is manufactured. Each of the axial holes 22 is surrounded by a flange 23, the flange 23 being a protruding structure located on the outer cylindrical face 18 of the insert 15. Two flanges 23 are distributed symmetrically on two sides of the front shaft hole 20, with a pin hole 24 being formed on each flange 23. The two pin holes 24 on the two flanges 23 distributed symmetrically on two sides of the front shaft hole 20 are distributed on two sides of the axis center of the throttle shaft 4. The protrusion height of the two flanges 23 on two sides of the front shaft hole 20 is greater than the protrusion height of the flanges 23 in other positions on the insert 15. Each of the flanges 23 extends from the first flange face 16 of the insert 15 to the second flange face 17. The interiors of the front shaft hole 20 and rear shaft hole 21 are partially filled with the material from which the throttle housing 1 is manufactured. The axial holes 22 penetrate to the second flange face 17 from the first flange face 16 of the insert 15.

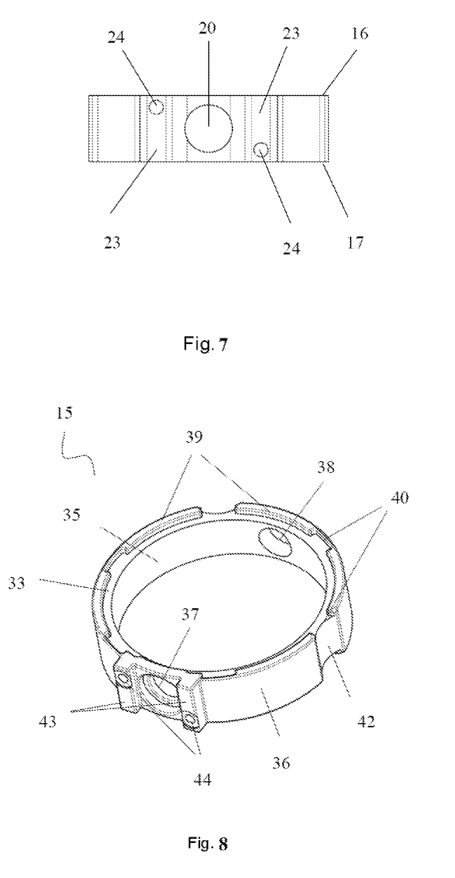

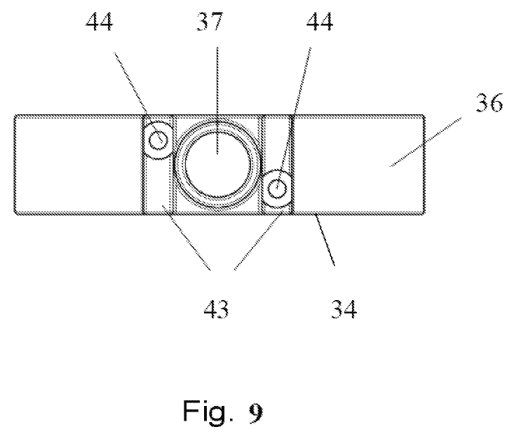

A drawing showing another structure of the insert 15 combined with the throttle housing 1 is not shown in this patent, but the specific structure thereof is shown in FIGS. 8 and 9. The insert 15 is an annular three-dimensional structure formed and enclosed by a first flange face 33, a second flange face 34, an inner cylindrical face 35 and an outer cylindrical face 36, the inner cylindrical face 35 of the insert 15 forming the throat of the throttle. A front shaft hole 37 and a rear shaft hole 38, positioned opposite each other, are formed in the insert 15. One end of the throttle shaft 4 is inserted into the front shaft hole 37 and then mounted in the second mounting hole 7 and third mounting hole 8. The other end of the throttle shaft 4 is inserted into the rear shaft hole 38 and then mounted in the first mounting hole 6. Multiple protruding structures 39 and the same number of recess structures 40 are formed on the first flange face 33 of the insert 15; any two adjacent protruding structures 39 are separated by one recess structure 40. Each of the protruding structures 39 has one side connected to the outer cylindrical face 36 of the insert 15. Provided on the outer cylindrical face 36 are at least two arcuate grooves 42 extending from the first flange face 33 to the second flange face 34, each of the arcuate grooves 42 sharing an edge with one of the recess structures 40. Two flanges 43 are distributed symmetrically on two sides of the front shaft hole 37 on the outer cylindrical face 36, with a pin hole 44 being formed on each flange 43, and the two pin holes 44 being distributed on two sides of the axis center of the throttle shaft 4. The interiors of the front shaft hole 37 and rear shaft hole 38 are partially filled with the material from which the throttle housing 1 is manufactured.

Preferably, the throttle also includes an outer cover assembly 25 fitted to the housing 1, an electrical connector 26 for supplying power to the electric machine 2 and transmitting signals, a magnet 27 mounted on the torque transfer means 3, and a position sensor 28 mounted inside the outer cover assembly 25.

During actual production, in the case of the insert 15 serving as an airflow delivery channel, a blank can be produced first by extrusion or diecasting, or by machining, then the insert is placed into a mold, and the throttle housing 1 containing the insert 15 is formed by injection molding. During the injection molding, the plastic material of the throttle housing 1 partially fills the front shaft hole 20 and rear shaft hole 21 of the insert 15, and to achieve precise airflow control, the required airflow channel precision is ensured by a small amount of machining.

Although the present device has been disclosed above through preferred embodiments, it is by no means limited to these. Changes and amendments of all kinds made within the spirit and scope of the present device by any person skilled in the art shall be included in the scope of protection of the present device. Thus the scope of protection of the present device shall be the scope defined by the claims.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronic throttle, comprising:
a throttle housing having a throttle throat;
a first mounting hole integrally formed as part of the throttle housing;
a second mounting hole integrally formed as part of the throttle housing;
an electric machine located inside the throttle housing;
a torque transfer means meshed with a gear on an output shaft of the electric machine;
a throttle shaft connected in a fixed manner to the torque transfer means, the throttle shaft passing through the throttle throat, and the throttle shaft being supported by being inserted into the first mounting hole and the second mounting hole in the throttle housing;
a butterfly valve which is mounted on the throttle shaft and located inside the throttle throat;
wherein the first mounting hole and the second mounting hole are located in the throttle housing on two sides of the throttle throat respectively, the second mounting hole being located on that side which is closer to the torque transfer means, and the first mounting hole and second mounting hole have hole inner diameters of the same size.

2. The electronic throttle of claim 1, further comprising a third mounting hole which is located in the throttle housing and used for supporting the throttle shaft, wherein the third mounting hole is located between the second mounting hole and the torque transfer means, and the third mounting hole is in communication with the second mounting hole.

3. The electronic throttle of claim 2, further comprising:
a supporting bearing mounted inside the third mounting hole such that a clearance fit is formed between the supported bearing and the throttle shaft; and
a sealing ring mounted on the periphery of the throttle shaft;
wherein the sealing ring is located on either side of the supporting bearing.

4. The electronic throttle of claim 3, further comprising:
an interference fit formed between an inner ring of the sealing ring and the throttle shaft; and
an interference fit formed between an outer ring of the sealing ring and the third mounting hole.

5. The electronic throttle of claim 3, the cross-sectional shape of the sealing ring further comprising at least one of the following shapes selected from the group consisting of X-shaped, B-shaped, Y-shaped, O-shaped and rectangular.

6. The electronic throttle of claim 3, further comprising a gap between the supporting bearing and the sealing ring in the axial direction of the throttle shaft.

7. The electronic throttle of claim 3, the supporting bearing further comprising a sliding bearing.

8. The electronic throttle of claim 1, further comprising an oil/grease or molybdenum disulphide which is spread between the first mounting hole and the throttle shaft.

9. The electronic throttle of claim 1, further comprising:
a first locating pin mounting groove formed on the throttle housing;
a second locating pin mounting groove formed on the throttle shaft; and
a locating pin mounting hole formed by a space between the first locating pin mounting groove and the second locating pin mounting groove.

10. The electronic throttle of claim 9, further comprising a locating pin mounted inside the locating pin mounting hole.

11. The electronic throttle of claim 10, wherein the first locating pin mounting groove, second locating pin mounting groove, locating pin mounting hole, and locating pin are all located inside the first mounting hole.

12. The electronic throttle of claim 1, the first mounting hole further comprising a blind hole.

13. The electronic throttle of claim 12, further comprising at least one small boss structure is formed at the bottom of the first mounting hole.

14. The electronic throttle of claim 13, wherein an end face of the throttle shaft located inside the first mounting hole, and a top surface of the boss structure are in contact with and press against each other.

15. The electronic throttle of claim 12, further comprising a gap formed between an end face of the throttle shaft located inside the first mounting hole and the bottom of the first mounting hole.

16. The electronic throttle of claim 1, further comprising an insert mounted inside the throttle housing.

17. The electronic throttle of claim 16, the insert further comprising:
an annular three-dimensional structure, further comprising:
an inner cylindrical face, the inner cylindrical face forming the throat of the throttle;
a first flange face;
a second flange face; and
an outer cylindrical face;
a front shaft hole formed in the insert;
a rear shaft hole formed in the insert, the front shaft hole and rear shaft hole being positioned opposite each other;
a plurality of axial holes formed on the first flange face of the insert such that each of the plurality of axial holes running in the axial direction of the insert, each axial hole being located between the outer cylindrical face and the inner cylindrical face, and the interior of each axial hole being filled with the material from which the throttle housing is manufactured;
wherein one end of the throttle shaft is inserted into the front shaft hole and then mounted in the second mounting hole and third mounting hole, and the other end of the throttle shaft is inserted into the rear shaft hole and then mounted in the first mounting hole.

18. The electronic throttle of claim 17, further comprising a flange, each of the axial holes is surrounded by the flange.

19. The electronic throttle of claim 17, the flange further comprising a protruding structure located on the outer cylindrical face of the insert.

20. The electronic throttle of claim 19, the flange further comprising two flanges distributed symmetrically on two sides of the front shaft hole.

21. The electronic throttle of claim 20, further comprising a pin hole being formed on each flange.

22. The electronic throttle of claim 21, wherein the two pin holes on the two flanges are distributed symmetrically on two sides of the front shaft hole are distributed on two sides of the axis center of the throttle shaft.

23. The electronic throttle of claim 21, wherein the protrusion height of the two flanges on two sides of the front shaft hole is greater than the protrusion height of the flanges in other positions on the insert.

24. The electronic throttle of claim 19, wherein each of the flanges extends from the first flange face of the insert to the second flange face.

25. The electronic throttle of claim 17, wherein the interiors of the front shaft hole and rear shaft hole are partially filled with the material from which the throttle housing is manufactured.

26. The electronic throttle of claim 17, wherein the axial holes penetrate to the second flange face from the first flange face of the insert.

27. The electronic throttle of claim 16, the insert further comprising:
an annular three-dimensional structure, further comprising:
an inner cylindrical face, the inner cylindrical face forming the throat of the throttle;
a first flange face;
a second flange face;
an outer cylindrical face;
a front shaft hole formed in the insert;
a rear shaft hole formed in the insert, the front shaft hole and rear shaft hole being positioned opposite each other;
a plurality of protruding structures formed on the first flange face of the insert; and
a plurality of recess structures are formed on the first flange face of the insert, any two adjacent protruding structures being separated by one recess structure;
wherein one end of the throttle shaft is inserted into the front shaft hole and then mounted in the second mounting hole and third mounting hole, and the other end of the throttle shaft is inserted into the rear shaft hole and then mounted in the first mounting hole.

28. The electronic throttle of claim 27, wherein each of the protruding structures has one side connected to the outer cylindrical face of the insert.

29. The electronic throttle of claim 27, further comprising at least two arcuate grooves provided on the outer cylindrical face, each of the at least two arcuate grooves extending from the first flange face to the second flange face, each of the arcuate grooves sharing an edge with one of the recess structures.

30. The electronic throttle of claim 27, further comprising a pin hole formed on each flange, wherein the two flanges are distributed symmetrically on two sides of the front shaft hole on the outer cylindrical face, and the two pin holes are distributed on two sides of the axis center of the throttle shaft.

31. The electronic throttle of claim 27, wherein the interiors of the front shaft hole and rear shaft hole are partially filled with the material from which the throttle housing is manufactured.

32. The electronic throttle of claim 1, further comprising:
an outer cover assembly fitted to the housing;
an electrical connector for supplying power to the electric machine and transmitting signals;
a magnet mounted on the torque transfer means; and
a position sensor mounted inside the outer cover assembly.
